(19) United States
(12) Patent Application Publication
(10) Pub. No.: US 2015/0029153 A1
(43) Pub. Date: Jan. 29, 2015

(54) ELECTRICALLY CONDUCTIVE DEVICE TO BE APPLIED TO A PORTION OF A GLOVE FOR USE WITH TOUCH SCREEN DEVICE

(71) Applicant: Touchtips LLC, Austin, TX (US)

(72) Inventors: Thomas Lovell Williams, Austin, TX (US); Alex Lawson, Washington, DC (US); Greg Sarmas, SR., Lake Forest, IL (US)

(21) Appl. No.: 14/514,622

(22) Filed: Oct. 15, 2014

Related U.S. Application Data
(63) Continuation of application No. 13/115,213, filed on May 25, 2011.
(60) Provisional application No. 61/349,825, filed on May 29, 2010.

(51) Int. Cl. G06F 3/0354; G06F 3/044; A41D 19/00; G06F 3/039

(52) U.S. Cl. CPC G06F 3/03545; G06F 3/039; G06F 3/044; A41D 19/0024; G06F 2203/0331
USPC 345/174

(57) ABSTRACT

A device is removeably attachable to a fingertip portion of a glove worn on a hand of a user for use with a touch screen device. The device includes a conductive film layer and an adhesive layer secured to the conductive film layer. The adhesive layer is removeably attachable to the glove, and the conductive film layer is capable of contacting the touch screen device.

### REFERENCE TO RELATED APPLICATIONS

This application is a continuation of U.S. patent application Ser. No. 13/115,213 filed May 25, 2011, which claims priority to U.S. Provisional Patent Application No. 61/349,825 filed May 29, 2010.

### BACKGROUND OF THE INVENTION

The present invention relates generally to an electrically conductive device to be attached to at least one fingertip portion of a glove with an adhesive that can be used with a touch screen device.

Personal digital assistants include a touch screen that is usually activated by the touch of a finger tip. Many personal digital assistants use a capacitive touch screen that requires the actual contact of a fingertip, which due to the conductivity of the skin, perturbs the field of the touch screen. When a user is wearing gloves, the material of the glove acts as an electrical insulator, and the capacitive touch screen cannot detect the conductivity of the skin of the fingertip through the gloves. Therefore, the touch screen device does not work.

In one prior device, a piece of material that is electrically conductive material is attached to the tip of a glove with bendable prongs that are inserted and punctured through the material of the glove. In another device, an electrically conductive material is woven or embedded into the fabric of tips of the fingertips of the glove. However, this device is not removable.

### SUMMARY OF THE INVENTION

A device is removeably attachable to a fingertip portion of a glove worn on a hand of a user for use with a touch screen device. The device includes a conductive film layer and an adhesive layer secured to the conductive film layer. The adhesive layer is removeably attachable to the glove, and the conductive film layer is capable of contacting the touch screen device.

A device is removeably attachable to a fingertip portion of a glove worn on a hand of a user for use with a touch screen device. The device includes a conductive film layer of polyurethane or polyvinyl chloride, and a portion of an upper surface of the conductive film layer includes a raised portion. The device also includes an adhesive layer secured to a lower surface of the conductive film layer. The adhesive layer is removeably attachable to the glove, and the conductive film layer is capable of contacting the touch screen device.

A method creates a device that is removably attachable to a fingertip portion of a glove worn on a hand of a user for use with a touch screen device. The method includes the steps of extruding a conductive film and rolling the film. The method also includes the steps of securing an adhesive to a lower surface of the conductive film and die cutting the film to create the device, and a release paper is attached on an opposing surface of the adhesive layer.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates a touch screen device and a glove including a conductive tip that is removeably attached to a fingertip portion of the glove;

FIG. 2a schematically illustrates a top view of the conductive tip;

FIG. 2b schematically illustrates a side view of the conductive tip of FIG. 2a;

FIG. 3a schematically illustrates a top view of an alternate conductive tip including a raised surface;

FIG. 3b schematically illustrates a side view of the conductive tip of FIG. 3a;

FIG. 4 schematically illustrates a chart showing the method of forming the conductive tip;

FIG. 5 schematically illustrates an apparatus that extrudes an extruded conductive film sheet;

FIG. 6 schematically illustrates an apparatus that rolls and adds texture to the extruded conductive film sheet;

FIG. 7A schematically illustrates an apparatus that applies an adhesive with a release paper to the extruded conductive film sheet;

FIG. 7B schematically illustrates a layer of adhesive material prior to application to the extruded conductive film sheet;

FIG. 7C schematically illustrates an adhesive layer applied to the extruded conductive film sheet;

FIG. 8 schematically illustrates an apparatus that die cuts the extruded conductive film sheet on the release paper to form conductive tips;

FIG. 9 schematically illustrates an apparatus that applies colored dye to the conductive tips on the release paper;

FIG. 10 schematically illustrates an apparatus that dries the conductive tips on the release paper; and

FIG. 11 schematically illustrates the conductive tips on the release paper for retail sale.

### DETAILED DESCRIPTION OF THE PREFERRED EMBODIMENT

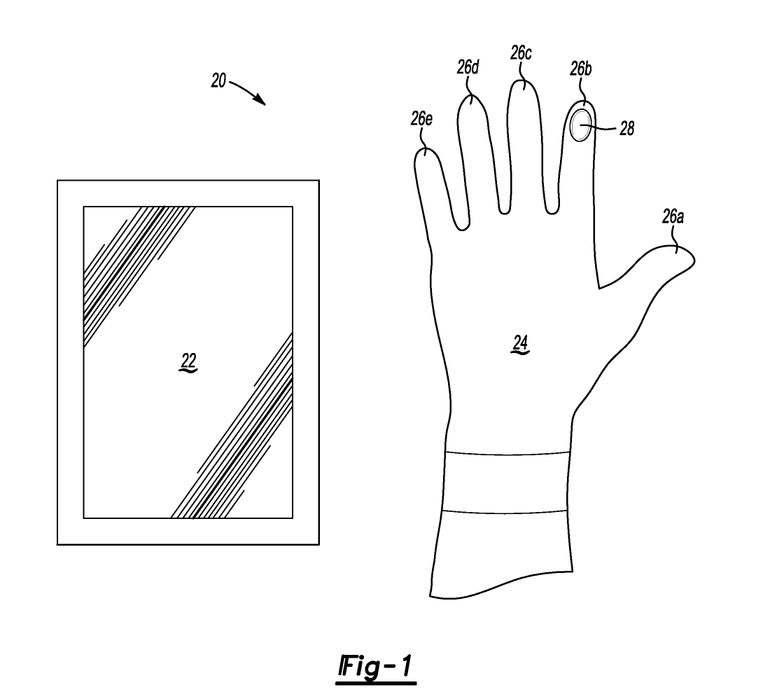

FIG. 1 illustrates a touch screen device 20 including a capacitive touch screen 22. The capacitive touch screen 22 is touched by a user when using the touch screen device 20. The touch screen device 20 can be a personal digital assistant, a touch screen computer, a tablet, machinery, equipment or any other device that includes a capacitive touch screen 22.

FIG. 1 also illustrates a glove 24 worn on a hand of the user. The glove 24 includes a thumb portion 26a, a pointer finger portion 26b, a middle finger portion 26c, a ring finger portion 26d, and a pinkie portion 26e. In the example of FIG. 1, a conductive tip 28 is adhered to the finger tip portion of the pointer finger portion 26b of the glove 24 with an adhesive layer 32. However, the conductive tip 28 can be adhered to the fingertip portion of any of the other portions 26a, 26c, 26d and 26e or more than one of the portions 26a, 26b, 26c, 26d and 26e. The conductive tip 28 allows the user to use the touch screen device 20 without removing the glove 24 and simulate the reactivity and contact of a human finger. The conductive tip 28 is removably attachable to the desired fingertip portion of the glove 24 by peeling the conductive tip 28 from the glove 24.

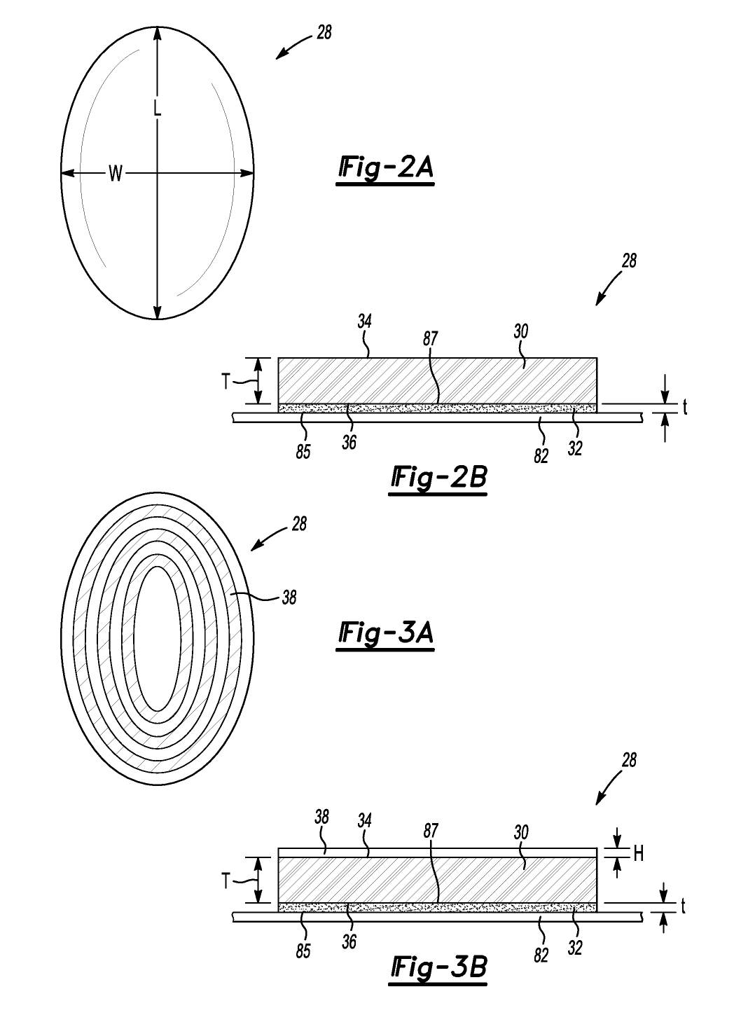

FIG. 2a illustrates a top view of the conductive tip 28, and FIG. 2b illustrates a side view of the conductive tip 28. In one example, the conductive tip 28 is substantially oval in shape. However, the conductive tip 28 can have any shape.

The conductive tip 28 includes a conductive film portion 30 and the adhesive layer 32. The conductive film portion 30 has an upper surface 34 that is exposed and is used to touch the capacitive touch screen 22 and a lower surface 36 to which the adhesive layer 32 is applied. The adhesive layer 32 can cover the entire lower surface 36 of the conductive film portion 30 or only a portion of the lower surface 36 of the conductive film portion 30.

A lower surface 85 of the adhesive layer 32 is applied on release paper 82. To use the conductive tip 28, the conductive tip 28 is removed from the release paper 82 to expose the adhesive layer 32. The adhesive layer 32 is applied to the fingertip portion of the desired finger portion 26 of the glove 26. The conductive tip 28 can then be used with the touch screen device 20.

The conducive tip 28 can have any dimensions that fit on the fingertip portion of the glove 24. For example, the conductive tips 28 can be sold in different sizes for different applications and types of gloves.

The conductive film portion 30 can be made of a film material that is flexible, easy to die cut, approved for medical applications, and have a great tensile strength. For example, the conductive film portion 30 can be a polymer or a thermoplastic polymer. For example, the conductive film portion 30 is polypolyurethane film (PUR) or polyvinyl chloride (PVC). In one example, the conducive film portion 30 is black. In one example, the conductive film portion 30 can have a thickness T of approximately 1.0, 1.25, 2.0 or 2.5 mils.

The adhesive layer 32 is a pressure sensitive hypoallergenic adhesive that is approved by the United States Food and Drug Administration. The adhesive layer 32 has a thickness t. In one example, the adhesive layer 32 has a thickness of approximately 2.0 mils. In one example, the adhesive layer 32 is MED 5512, manufactured by Avery Dennison of Chicago Ill. The adhesive layer 32 can also be P1500, manufactured by 3M of St. Paul, Minn.

FIG. 3a illustrates a top view of an alternate conductive tip 28 that includes a raised surface 38 that is raised relative to the upper surface 34 of the conductive tip 30, and FIG. 3b illustrates a side view of the alternate conductive tip. The raised surface 38 can define a design, such as an image or graphic. In one example, the raised surface 38 is defined by a plurality of concentric ovals. The raised surface 38 can have a thickness H of approximately 0.25 mils to 1.50 mils.

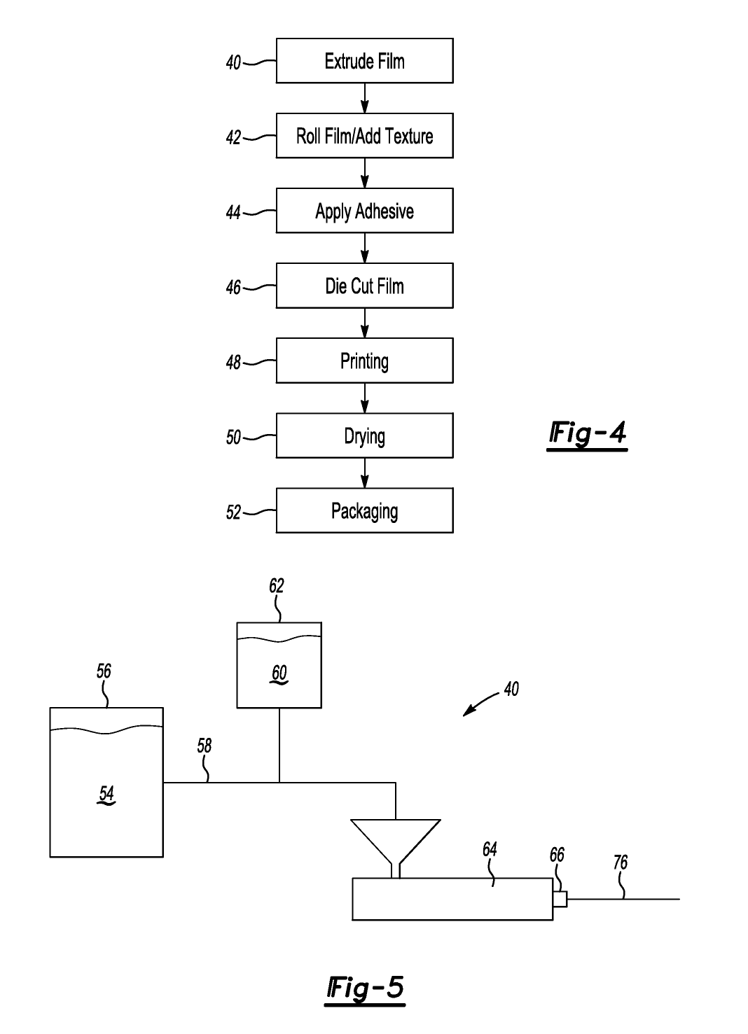

FIG. 4 illustrates a method of making the conductive tip 28. The method includes the step of extruding 40 an extruded conductive film sheet 76, the steps of rolling and adding texture (optional) 42 to the extruded conductive film sheet 76, the step of applying 44 the adhesive layer 32 with a release paper 82, the step 46 of die cutting the extruded conductive film sheet 76, the step of printing, such as adding color 48 (optional), the step of drying 50, and the step of packaging 52. Each of these steps will be discussed in more detail below.

FIG. 5 illustrates the step 40 of extruding the extruded conductive film sheet 76. A base material 54 of the conductive film portion 30 is contained in a bulk tank silo 56. The base material 54 is directed along a line 58, and additional raw materials, additives and/or colorants 60 contained in a silo 62 can be added to the base material 54. A colorant can be added to provide color to the material. In one example, a heat sensitive material can be added. In this example, a micro-encapsulated polyester resin based plastic is added that changes color when exposed to a specific temperature. The combined material is then delivered to an extruder 64, such as a barrel extruder, that extrudes the extruded conductive film sheet 76, slightly heated, from an extrusion head 66. In one example, the extruder 64 is a single screw extruder or a twin screw extruder.

FIG. 6 illustrates the step 42 of rolling and adding texture (optional) to the extruded conductive film sheet 76. The extruded conductive film sheet 76 is directed between two rollers 68 and 70 that roll the extruded conductive film sheet 76 to the desired thickness T. If a design created by a raised surface 38 is to be added to the extruded conductive film sheet 76, the rollers 68 and 70 can includes a patterned image that will create the raised surface 38 having the desired thickness H. The rollers 68 and 70 can be changed depending on the desired pattern and the desired thickness H of the raised surface 38.

In one example, the rollers 68 and 70 are heated to create the embossed raised surface 38. In one example, the rollers 68 and 70 are not heated, and the residual heat from the extruded conductive film sheet 76 allow the extruded conductive film sheet 76 to be soft enough such that the rollers 68 and 70 can create the embossed raised surface 38 without heating the rollers 68 and 70. This ability depends on the distance X between the extrusion head 66 and the rollers 68 and 70. After passing through the rollers 68 and 70, the extruded conductive film sheet 76 passes over and/or between a series of rollers 72 and is rolled around a rewind station 74.

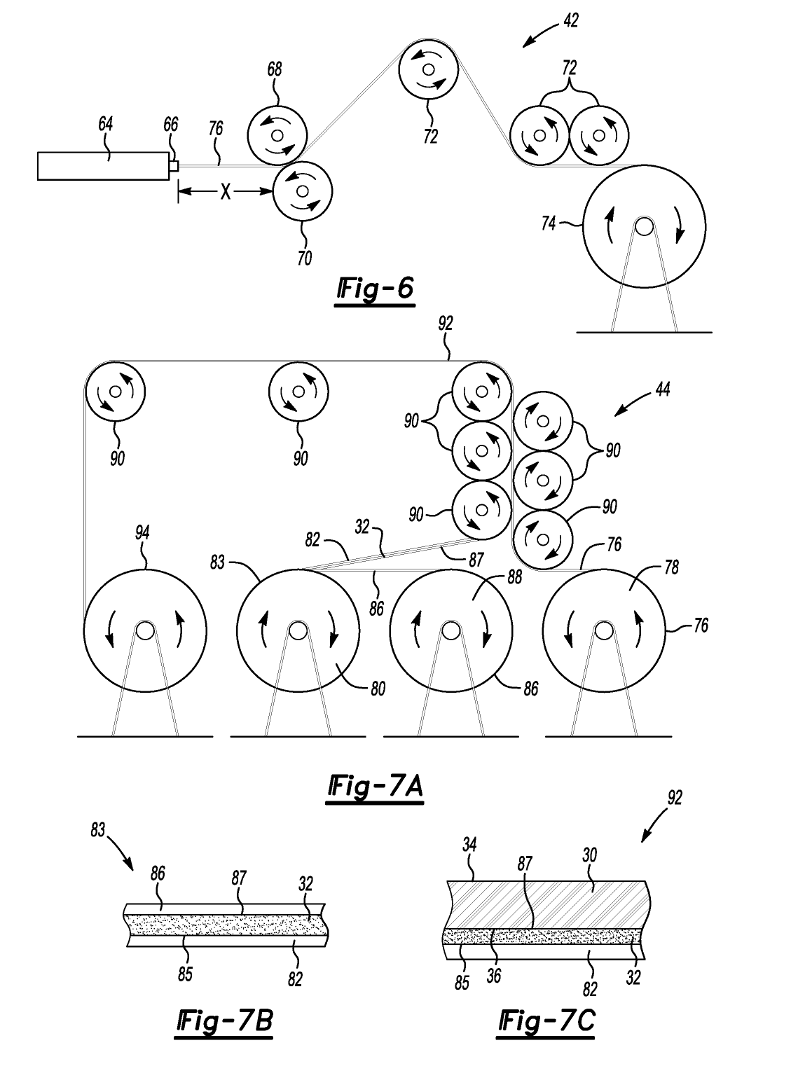

FIG. 7A illustrates the step 44 of applying the adhesive layer 32 to the extruded conductive film sheet 76. The extruded conductive film sheet 76 (which can be embossed to include the raised surface 38) is wrapped around an unwind station 78 (which can be the rewind station 74). A layer of adhesive material 83 is wrapped around another unwind station 80. As shown in FIG. 7B, the layer of adhesive material 83 includes the adhesive layer 32 which is between the release paper 82 and a protective film 86. The lower surface 85 of the adhesive layer 32 contacts the release paper 82. In one example, the release paper 82 is Tyvek® manufactured by E. I. DuPont De Nemours and Company of Wilmington, Del. In one example, the release paper 82 is Kimdura® manufactured by Neenah Paper, Inc. of Alpharetta, Ga. Grade 5614 PO Duraflex and 0321 BO Munsing LO clear room paper can be used as the release paper 82.

Returning to FIG. 7A, as the adhesive material 83 is unwound from the unwind station 80, the protective film 86 is removed and wrapped around the rewind station 88. This exposes the upper surface 87 of the adhesive layer 32. As a result, the adhesive layer 32 with the release paper 82 is pulled towards a series of rollers 90 (shown magnified in FIG. 7A). The upper surface 87 of the adhesive layer 32 contacts the extruded conductive film sheet 76, and pressure is applied to adhere the adhesive layer 32 to the extruded conductive film sheet 76 while traveling between the rollers 90. If the extruded conductive film sheet 76 includes any images or raised surfaces 38, the raised surfaces 38 are located on the upper surface 34 of the extruded conductive film sheet 76 that is opposite to the lower surface 36 of the extruded conductive film sheet 76 that is adhered to the adhesive layer 32.

After leaving the rollers 90, as shown in FIG. 7C, a sheet 92 is created including the adhesive layer 32 adhered to the lower surface 36 of the extruded conductive film sheet 76 and the release paper 82 attached to the lower surface 85 of the adhesive layer 32. The sheet 92 is then wound on a rewind station 94.

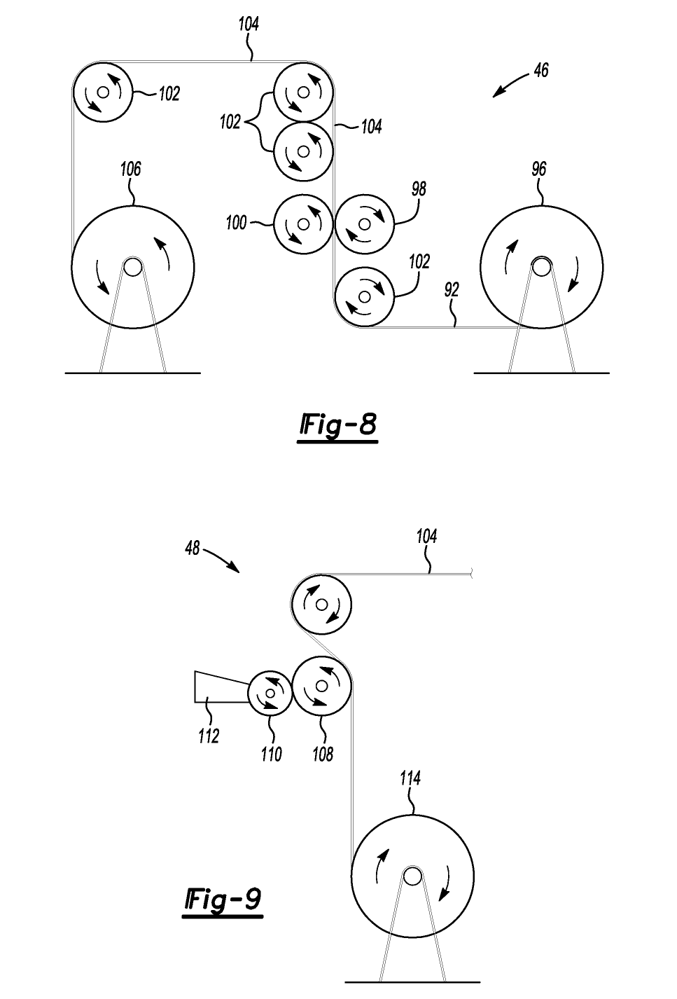

FIG. 8 illustrates the step 45 of die cutting the sheet 92. The sheet 92 is wound on a unwind station 96 (which can be the rewind station 94). The sheet 92 is rolled between an anvil roller 100 and a roller 98 with a die plate for die cutting the desired shape of the capacitive tip 28 (such as oval) to create a die cut film 104. Electrical and mechanical controls are used to manipulate tension and can aid in guiding and stretching the film and help with flatness and smoothness.

Alternately, die cut raised sponge-sticky based foam material could be mounted on the adhesive layer 32 and covered by urethane film. In another example, the sticky backed sponge foam material is replaced with a rigid circuit center tipped plastic disk that could be mounted on a pressure sensitive adhesive (PSA coated surface and covered by the urethane film.

The scrap material around the capacitive tip 28 is discarded, such as on a paper core on a shaft of the printing press. The die cut film 104 then is directed by rollers 102 to a rewind station 106.

FIG. 9 illustrates the step 48 of printing or adding color to the die cut film 104 to display a functional image of the conductive surface one utilizes to activate the touch screen 22 of the touch screen device 20. This step is optional depending on whether it is desired to add color to the die cut film 104. The die cut film 104 travels over a roller 108. An ink well 112 including a colored dye is deposited on an adjacent roller 110, which is in contact with the roller 108 to deposit the colored dye on the roller 108. It is possible that more than one ink well 112 can be employed to deposit more than one colored dye. As the die cut film 104 travels over the roller 108 (with the upper surface 34 of the die cut film 104 facing the roller 108), the colored dye on the roller 108 is transferred onto the die cut film 114 or on the raised surface 38 if the die cut film 114 includes a raised surface 38. The die cut film 114 is then wound around an unwind station 114. Alternately, the ink can be applied under the extruded conductive film sheet 76 prior to addition of the adhesive layer 32.

A plastisol based “thermo-chromic” ink can be used, which can change color. For example, the ink can be thermochromic, which changes color when exposed to heat, piezochromic, which changes colors when pressure is applied, or photochromic, which changes color when exposed to UV light. Besides rolling, the ink can be applied by a silk-screening process.

FIG. 10 illustrates the step 50 of drying the die cut film 104. The die cut film 104 (which may or may not be colored) travels over rollers 118 and under a drying device 116. In one example, the drying device 116 can be an ultraviolet light, an electron beam dryer, a heat lamp, a gas dryer, or any type of dryer. The type of drying device 116 can depend on the type of ink used. After being dried, the die cut film 114 is rolled around a rewind station 120.

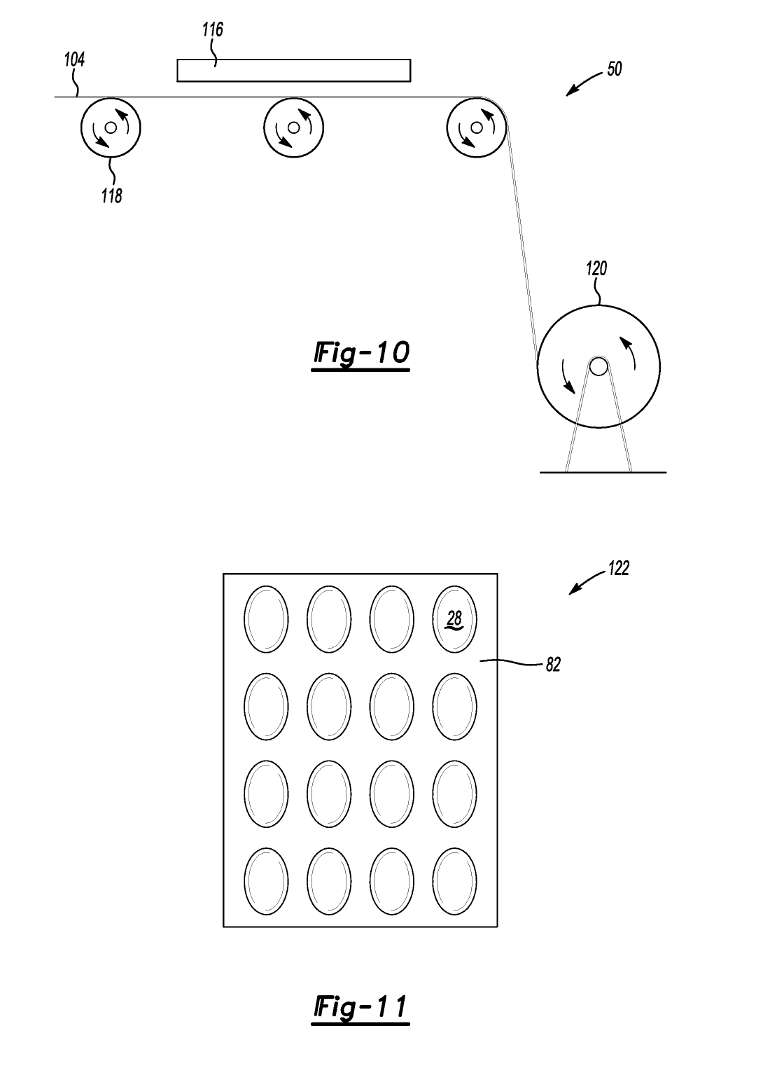

The die cut film 114 can then be cut into portions sized for retail sale in step 52. As shown in FIG. 11, the release paper 82 including the conductive tips 28 is cut to retail sized sheets 112 that includes a plurality of conductive tips 28 on the surface of the release paper 82. These retail sized sheets 112 are then packaged for sale to consumers.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A combination comprising:
a capacitive electric touch screen device;
a glove including a fingertip portion; and
a fingertip device including a conductive film layer that contacts and activates the touch screen device, wherein the fingertip device includes an adhesive layer secured to the conductive film layer that removably secures the fingertip device to the fingertip portion of the glove.

2. The combination as recited in claim 1, wherein the fingertip device is substantially oval.

3. The combination as recited in claim 1, including a release paper including a plurality of fingertip devices, wherein the adhesive layer of each of the plurality of fingertip devices contacts the release paper prior to being removably attached to the fingertip portion of the glove.

4. The combination as recited in claim 1, wherein the fingertip device is removable from the fingertip portion of the glove.

5. The combination as recited in claim 4, wherein a different fingertip device is removably attached to the fingertip portion of the glove.

6. The combination as recited in claim 1, wherein an upper surface of the conductive film layer includes a raised surface.

7. The combination as recited in claim 6, wherein the raised surface includes a curved surface.

8. The combination as recited in claim 6, wherein the raised surface has a thickness between 0.25 to 1.50 mils.

9. The combination as recited in claim 1, wherein conductive film layer is one of a polymer or a thermoplastic.

10. The combination as recited in claim 9, wherein conductive film layer is a polymer, and the polymer is one of polypolyurethane or polyvinyl chloride.

11. The combination as recited in claim 1, wherein the conductive film layer has a thickness of between 1.0 and 2.5 mils.

12. The combination as recited in claim 1, wherein the adhesive layer has a thickness of 2.0 mils.

13. The combination as recited in claim 1, wherein the conductive film layer includes a heat sensitive feature.

14. The combination as recited in claim 1, wherein the conductive film layer includes a dye.

15. The combination as recited in claim 1, wherein the capacitive electric touch screen device is one of computer, a tablet or a phone.

16. A method of attaching a fingertip device to a glove, the method comprising the steps of:
removing a fingertip device including a conductive film layer and an adhesive layer from a sheet of release paper;
applying the adhesive layer of the fingertip device to a fingertip portion of a glove to removably attach the fingertip device to the glove; and
contacting the fingertip device with a touch screen device to activate the touch screen device.

17. The method as recited in claim 16, including the step of removing the fingertip device from the fingertip portion of the glove.

18. The method as recited in claim 17, wherein the step of removing the fingertip device from the fingertip portion of the glove includes peeling the fingertip device from the fingertip portion of the glove.
